(19) United States
(12) Patent Application Publication
(10) Pub. No.: US 2011/0042564 A1
(43) Pub. Date: Feb. 24, 2011

(54) LASER ABLATION MASS ANALYZING APPARATUS

(76) Inventors: Yasuhide Naito, Shizuoka (JP); Manabu Heya, Shizuoka (JP); Naohisa Miyazaki, Osaka (JP)

Correspondence Address: Ditthavong Mori & Steiner, P.C., 918 Prince Street, Alexandria, VA, 22314, US

(21) Appl. No.: 12/544,299

(22) Filed: Aug. 20, 2009

(51) Int. Cl. H01J 49/26; H01J 49/42; H01J 49/40; H01J 49/30; H01J 49/04

(52) U.S. Cl. 250/287; 250/281; 250/292; 250/298; 250/291; 250/288

(57) ABSTRACT

A laser ablation mass analyzing apparatus includes a sample stage, a laser irradiation unit, a pneumatic transport unit, an ion source, and an analyzer. The sample stage holds a hair sample to be positioned accurately, and the laser irradiation unit irradiates an optional position on the hair such as a tip of the hair to generate ablation. The elements contained in the hair atomized by the ablation are extracted by the pneumatic transport system, and reach the ion source. Neutral atoms of the elements contained in the hair are ionized in the ion source by electron beam irradiation or light irradiation, to analyze mass of the ions obtained of the elements contained in the hair, by the analyzer.

### TECHNICAL FIELD

Described herein is a mass analyzing apparatus using laser ablation, wherein especially the laser ablation is used to measure a distribution state of a trace element(s) and a specific element(s) in a hair.

### BACKGROUND

In the conventional technologies of such a mass analyzing apparatus using laser ablation, laser ablation is performed in a vacuum device, thereby directly generating ionic species, and a mass analysis of the generated ionic species is carried out (refer to Japanese Patent Application Publication No. 2002-328114), or laser ablation is performed in atmospheric pressure, thereby generating neutral species, and then generated neutral species are transported by carrier gas so that mass analysis is carried out by an inductively-coupled plasma mass spectrometry (ICP-MS) apparatus (refer to Japanese Patent Application Publication No. 2006-153660). In either case, a sample is decomposed and extracted at atomic level by laser ablation, so as to carry out the mass analysis. Such technologies are put to practical use as an elemental analysis technology. They have the high sensitivity of from a ppt (10⁻¹² g/1 g) level to a ppq (10⁻⁵ g/1 g) level.

In order to directly generate ions of an element or a high molecular compound, which is an object to be measured, it is necessary to provide a complicated device mechanism which places a sample to be measured, on a sample stage, and replaces it with another sample, in a high vacuum chamber, or to make sufficient examination about a sample preparation (blending) for promoting ionization etc.

When ICP-MS is used for analysis of neutral species generated by the laser ablation, a special transport mechanism is required to introduce the generated neutral species into an ICP-MS apparatus. A system in which these mechanisms are integrated is large in size and expensive, and the transport efficiency thereof from the laser ablation device to an ICP-MS apparatus is not high.

### SUMMARY

A hair mineral inspection is a preventive medicine inspection with the about 30 years of experience, and is utilized in the United States by 10,000 or more medical doctors for dynamic analysis of nutrients in a body. In recent years, it is applied to an orthomolecular therapy, anti-aging, and prediction of a cancer. Thus a progress thereof is remarkable and it is the latest medical-diagnosis technology.

As the features of the hair mineral inspection, it is possible to make an examination tracing back to the past, while it is a non-invasive diagnostic method without a test subject's pain or physical strain. Since a hair grows at a base thereof at speed of 1 cm per month, information for the past one year is recorded in a 12 cm hair. Therefore, in the hair mineral inspection, an analytical method capable of acquiring the information of the mineral distribution in the hair length direction is required.

Although currently such a laser ablation mass analyzing apparatus (laser ablation mass spectrometer) for general-purposes is mainly used for analysis of an element(s) in a hair, since only a proficient operator can operate it and the apparatus is large in size and expensive, usages thereof are necessarily limited to those in a research institution or a specialized agency. Therefore, since such a hair mineral inspection has to be conducted in form of a deposit analysis in which a sample is deposited in the specialized agency so that the number of samples to be examined is very small, it is not possible to meet potential demands of a hair mineral inspection.

It is an object of the present invention to offer an analytical method of an element(s) in hair which needs neither a large-scale equipment nor a proficient operator and is easy to use, by using a dedicated laser ablation mass analyzing apparatus (spectrometer) for hair analysis.

In order to solve the above problem, the present laser ablation mass analyzing apparatus has a sample stage on which a hair is held and positioned; a laser irradiation unit which generates ablation by irradiating a position of the hair with a laser beam; a pneumatic transport unit which extracts elements in the hair atomized by the ablation; an ion source which ionizes neutral atoms of the elements in the hair which are injected through the pneumatic transport unit by electron beam irradiation or light irradiation; and an analyzer which analyzes mass of ions of the elements in the hair which are generated in the ion source.

In the above-mentioned structure, the sample stage and the laser irradiation unit can trace correctly the position information of an element(s) in a hair, which is distributed over the hair in a length direction thereof, i.e., a record of elemental information about time at which the element was accumulated in the hair. In addition, in the pneumatic transport system, while neutral atoms of an element(s) in the hair, which are generated by the laser ablation, are highly efficiently collected, it is possible to coarsely separate product species (atoms, clusters, etc.) generated by the ablation by using differences in mobility in the gas flow. While, in the above-mentioned ion source, it is possible to obtain an ionic yield higher than that in the case where ions are directly generated by laser ablation when applying an ionization method such as electron ionization (EI) with high ionization efficiency with respect to atoms in the gaseous phase, the laser ablation can be set to an optimal condition about atomization of the element(s) in the hair, regardless of the ionization condition. Further, a loss of ions can be kept to the minimum by providing an ion source close to an analyzer. Therefore, there is an effect that the elemental history information recorded in the hair can be analyzed with high sensitivity.

In the above-mentioned structure, the sample stage may be under atmospheric pressure. In such a case, since a vacuum load lock mechanism is not necessary when replacing a hair sample with a new one so that the apparatus can be simplified, an operational load can be reduced, and hours of the work can be shortened, whereby there is an effect that an element(s) in the hair can be easily analyzed.

In the present laser ablation mass analyzing apparatus, the analyzer may be a quadrupole mass filter type, quadrupole ion trap type, linear ion trap type, time-of-flight type, magnetic sector type, ion cyclotron resonance type, Fourier transform ion cyclotron resonance type, or Kingdon trap type analyzer.

In the case where the analyzer is a quadrupole mass filter type analyzer, a measurement dynamic range and noise tolerance can be improved by setting up operating conditions of a quadrupole mass filter so that only ions of specific mass can transmit through the filter. Therefore, such an analyzer has an effect that a trace element(s) in the hair can be analyzed with high sensitivity.

In the present laser ablation mass analyzing apparatus, the pneumatic transport system may preferably have a transparent cell and a capillary (tube) which is connected to the transparent cell.

When the neutral atom of an element in a hair which is generated by laser ablation according to the above-mentioned structure is transported by a gas flow, loss of neutral atoms due to diffusion etc. is low, and recovering efficiency thereof is made to the maximum. Therefore, in such a case, there is an effect that the element(s) in a hair can be analyzed with high sensitivity.

Since in the above-mentioned structure, gas influx from the pneumatic transport system can be handled by a small-volume vacuum pump even if a hair sample is placed under atmospheric pressure, footprint downsizing of the apparatus and improvement in operability thereof can be attained. Therefore, in such a case, there is an effect that the element(s) in the hair can be easily analyzed.

In the present laser ablation mass analyzing apparatus, the laser irradiation unit may have preferably a plasma detector which detects whether or not there is ablation.

In the above-mentioned structure, since the laser irradiation unit can be adjusted to the optimal condition with respect to the ablation, independently of settings of the pneumatic transport system, the ion source, and the analyzer, improvement in operability thereof can be attained. Therefore, in such a case, there is an effect that an element(s) in the hair can be easily analyzed.

In the present laser ablation mass analyzing apparatus, the sample stage may preferably include a feeding (linear movement) mechanism which feeds and supplies a hair to a laser beam condensing position stably and continuously, by using an output signal from the plasma detector.

In the above-mentioned structure, since a portion of the hair to be measured can be scanned automatically while always judging whether there is ablation, it is possible to, automatically and at a high speed, analyze the position information of an element(s) in a hair, which is distributed over the hair in a length direction thereof, i.e., a record of elemental information about time at which the element was accumulated in the hair. Therefore, in such a case, there is an effect that an element(s) in a hair can be easily analyzed.

In the present laser ablation mass analyzing apparatus, the sample stage may preferably include a sample rotating mechanism having a rotation axis in the hair length direction, in addition to the feeding mechanism which moves the hair in the hair length direction. In addition, the rotation of the hair sample by the rotating mechanism may be preferably controlled in conjunction with a movement of the hair in the hair length direction.

In the above-mentioned structure, since it is possible to scan a laser irradiating portion of the hair sample over the entire circumference thereof, it is possible to increase the use efficiency of the hair sample, so that there is an effect that elemental history information accumulated in the hair can be analyzed with a high degree of accuracy.

As mentioned above, the hair sample can be easily handled in the present laser ablation mass analyzing apparatus, and the laser ablation mass analyzing apparatus does not require large scale equipment or a proficient operator therefor, so that it is possible to easily analyze a specific element(s) and a trace element(s) in a hair with high sensitivity.

### BRIEF DESCRIPTION OF DRAWINGS

Other features and advantages of the present laser ablation mass analyzing apparatus will be apparent from the ensuing description, taken in conjunction with the accompanying drawings, in which:

FIG. 1A shows a schematic block diagram of a laser ablation mass analyzing apparatus according to an embodiment;

FIG. 1B is a schematic front view of a laser ablation mass analyzing apparatus shown in FIG. 1A;

FIG. 2 is a frame format diagram of a main part of a sample stage and a laser irradiation unit of a laser ablation mass analyzing apparatus according to an embodiment; and

FIG. 3 is a frame format diagram of a main part of an ion source and an analyzer of a laser ablation mass analyzing apparatus according to an embodiment.

### DETAILED DESCRIPTION

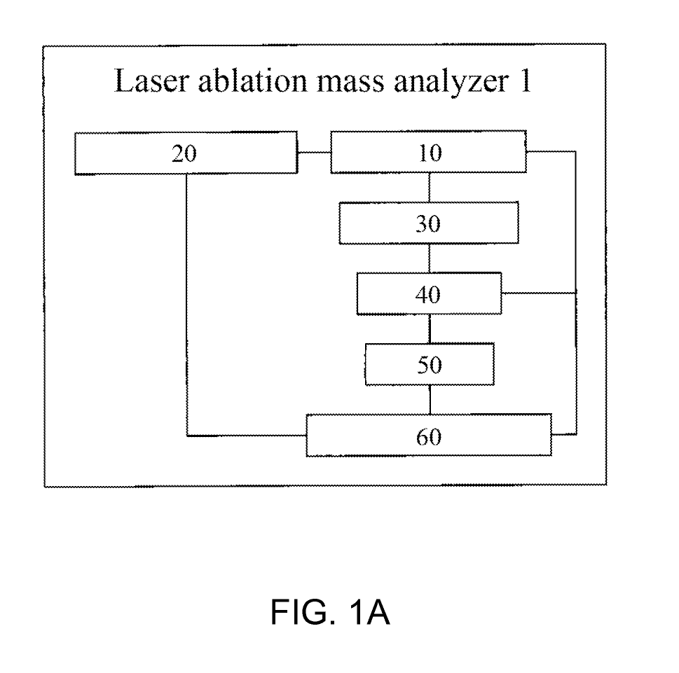

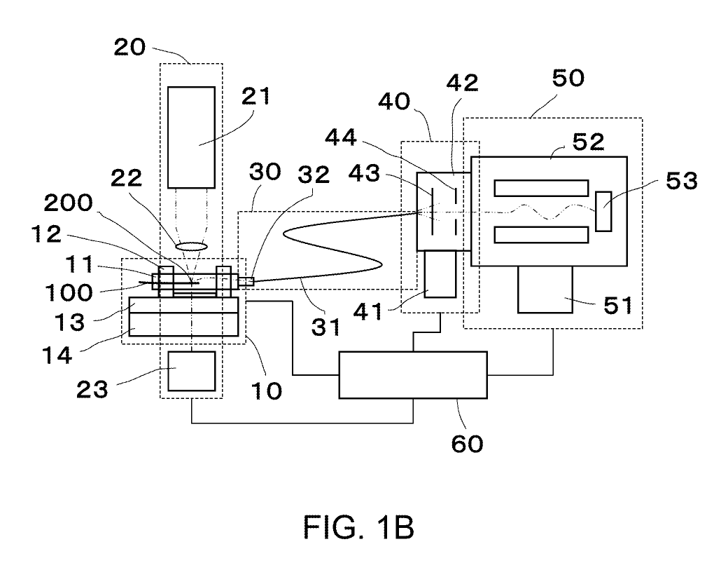

A description will now be given, referring to embodiments of the present laser ablation mass analyzing apparatus. While the claims are not limited to such embodiments, an appreciation of various aspects of the present laser ablation mass analyzing apparatus is best gained through a discussion of various examples thereof. An embodiment will be described, referring to FIG. 1.

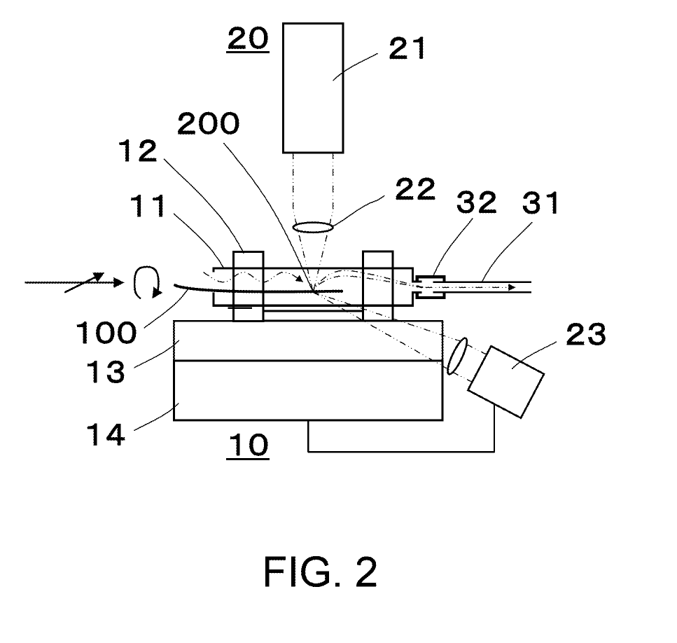

As shown in FIGS. 1A and 1B, a laser ablation mass analyzing apparatus 1 according to this embodiment includes a sample stage 10 which holds and accurately positions a hair sample under atmospheric pressure, a laser irradiation unit 20 which generates laser ablation on (a tip of) a hair, a pneumatic transport system 30 which collects products of the ablation, an ion source 40 which ionizes the transported element(s) in the hair, an analyzer 50 which conducts mass analysis of the elemental ions produced in the ion source, and a data processing control unit 60 that performs processing and recording of mass analysis data and performs control of each part of the apparatus. The sample stage 10 and the laser irradiation unit 20 are more concretely explained below, referring to FIG. 2. However, the sample stage 10 and the laser irradiation unit 20 according to the embodiment are not limited thereto.

FIG. 2 is a frame format diagram of a main part of the sample stage 10 and the laser irradiation unit 20 of a laser ablation mass analyzing apparatus according to the present embodiment. The sample stage 10 comprises a transparent cell 11 which holds and stores a hair sample, a rotation driving mechanism 12 which rotates the transparent cell 11, a dual-axis translation stage 13 on which the transparent cell 11 and the rotation driving mechanism 12 are mounted, and a dual-axis translation stage driving mechanism 14 which can actuate the dual-axis translation stage in x and y axes directions. There is an opening at one end of the transparent cell 11, wherein ambient air, dry air, or various kinds of inert gas can be introduced therefrom into the transparent cell. The other end thereof is connected to a capillary 31 which forms part of the pneumatic transport system 30, through a connector 32 having slide contact and air-sealing properties. The laser irradiation unit 20 includes a laser light source 21, a lens optical system 22 which condenses a laser beam at a point in the transparent cell 11, and a plasma detector 23.

In the above-mentioned structure, atomized elements in the hair which are generated by the laser ablation promptly ride a gas flow and are transported to the pneumatic transport unit. In this case, it is preferred that the gas flow is steady and stable, and flows in a fixed direction. As long as the transparent cell 11 realizes such a gas flow, the structure thereof is not in particular limited thereto. Since such a gas flow is specifically realizable by opening the transparent cell to atmospheric pressure, the transparent cell 11 does not need a particular structure of airtight sealing. In addition, the hair sample 100 is fixed thereto so as not to be blown off by the gas flow, but this can be easily realized by spring, a clasp, etc. If the connector 32 has a slidable joint mechanism made of, for example, TEFLON (Trademark of DuPont), so that it is possible to suppress leakage therefrom to the minimum while the slide contact property is kept.

In addition, in the structure, by returning an output signal from the plasma detector 23 to the dual-axis translation stage driving mechanism 14, an automatic control can be performed so that the laser beam condensing point 200 may not miss the portion to be measured on the hair sample 100, and the dual-axis translation stage 13 can be automatically actuated so that it may scan over the hair sample 100 in the length direction. It is preferred that the dual-axis translation stage 13 detects the amount of a displacement by itself and has, for example, a linear encoder. In addition, every time the transparent cell 11 to which the hair sample 100 is fixed, is rotated by one turn by the rotation driving mechanism 12, the dual-axis translation stage 13 is moved by a predetermined step in the hair length direction.

For example, the laser light source 21 may be but is not limited to, the fourth-harmonic wave of a pulsed Nd:YAG laser.

For example, the plasma detector 23 may be but is not limited to a photo-diode which has a spectral sensitivity characteristic in a visible region (white light).

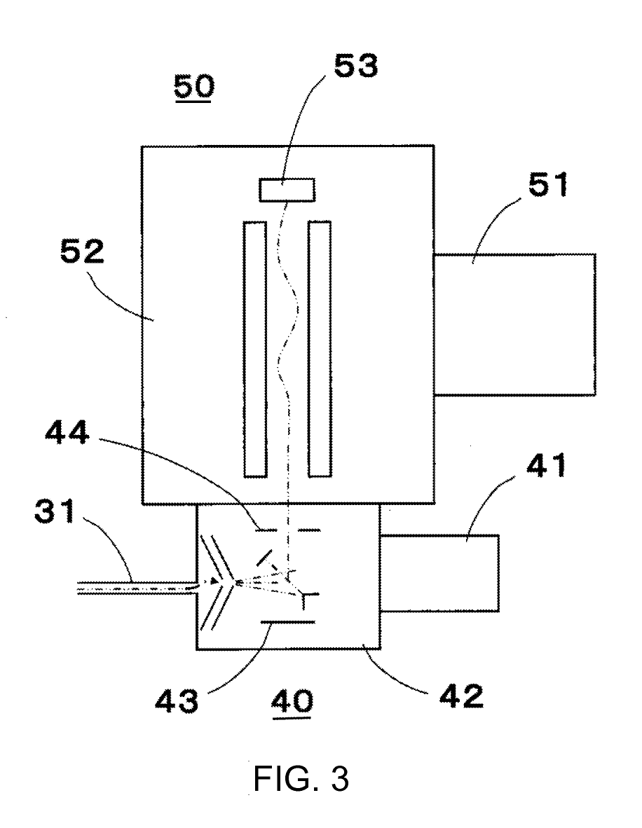

The ion source 40 and the analyzer 50 are more concretely explained below, referring to FIG. 3, but the ion source and the analyzer according to the embodiment are not limited thereto.

FIG. 3 is a frame format diagram of a main part of the ion source 40 and the analyzer 50 of the laser ablation mass analyzing apparatus according to an embodiment. The ion source 40 has a differential-pumping system 41 which gradually evacuates a gas introduced via the capillary 31 which forms part of the pneumatic transport system 30, an ionization chamber 42, a repeller electrode 43, and an extraction electrode 44. The analyzer 50 has a main vacuum pumping system 51, a mass separation region 52, and an ion detector 53.

The ionization method applied to the ionization chamber 42 may be any method, as long as an element(s) in a hair already atomized by ablation are ionized, and specifically a method having high ionization efficiency with respect to a gas atom(s) is preferable. For example, electron ionization (EI) may be used therefor, but the ionization method is not limited thereto.

The mass separation region 52 may be any means as long as it has performance sufficient to carry out mass separation of elemental ions. Specifically, a mass range thereof is preferably in a range of 1-200 u, and the mass resolution is approximately 500. Although, for example, a quadrupole mass filter may be used, it is not limited thereto.

For example, the ion detector 53 may be a secondary electron multiplier but is not limited to thereto.

The preceding description has been presented only to illustrate and describe exemplary embodiments of the present laser ablation mass analyzing apparatus. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

The contents of Japanese Patent Application Serial No. 2007-52016 filed Feb. 1, 2007 (published on Aug. 21, 2008 as Japanese Patent Application No. 2008-191134) are incorporated herein by reference in its entirety.

What is claimed is:

1. A laser ablation mass analyzing apparatus comprising:
a sample stage on which a hair is held and positioned;
a laser irradiation unit which generates ablation by irradiating laser beam at a position of the hair;
a pneumatic transport unit which extracts elements in the hair atomized by the ablation;
an ion source which ionizes neutral atoms of the elements in the hair which are injected through the pneumatic transport unit by electron beam irradiation or light irradiation; and
an analyzer which analyzes mass of ions of the elements in the hair which are generated in the ion source.

2. The laser ablation mass analyzing apparatus according to claim 1, wherein the analyzer is a quadrupole mass filter type, quadrupole ion trap type, linear ion trap type, time-of-flight type, magnetic sector type, ion cyclotron resonance type, Fourier transform ion cyclotron resonance type, or Kingdon trap type analyzer.

3. The laser ablation mass analyzing apparatus according to claim 1, wherein the pneumatic transport unit comprises a transparent cell, and capillary connected to the transparent cell.

4. The laser ablation mass analyzing apparatus according to claim 1, further comprising a plasma detector which determines whether or not there is laser ablation, and a feed mechanism which feeds the hair to a laser beam condensing position by using an output from the plasma detector.

5. The laser ablation mass analyzing apparatus according to claim 2, further comprising a plasma detector which determines whether or not there is laser ablation, and a feed mechanism which feeds the hair to a laser beam condensing position by using an output from the plasma detector.

6. The laser ablation mass analyzing apparatus according to claim 3, further comprising a plasma detector which determines whether or not there is laser ablation, and a feed mechanism which feeds the hair to a laser beam condensing position by using an output from the plasma detector.

7. The laser ablation mass analyzing apparatus according to claim 1, wherein the sample stage is under atmospheric pressure.

8. The laser ablation mass analyzing apparatus according to claim 2, wherein the quadrupole mass filter type analyzer has a quadrupole mass filter which is set so that only ions of specific mass can transmit through the quadrupole mass filter.

9. The laser ablation mass analyzing apparatus according to claim 1, wherein the sample stage includes a sample rotating mechanism having a rotation axis in the hair length direction.

10. The laser ablation mass analyzing apparatus according to claim 1, further including a connector connecting the laser irradiation unit to the pneumatic transport unit.

11. The laser ablation mass analyzing apparatus according to claim 10, wherein the connector has a slidable joint mechanism.

12. The laser ablation mass analyzing apparatus according to claim 1, wherein the laser irradiation unit includes a light source, a lens optical system which condenses a laser beam at a point in the transparent cell, and a plasma detector.

13. The laser ablation mass analyzing apparatus according to claim 1, wherein the laser light source is the fourth-harmonic wave of a pulsed Nd:YAG laser.

14. The laser ablation mass analyzing apparatus according to claim 4, wherein the plasma detector is a photo-diode which has a spectral sensitivity characteristic in a visible region.

15. The laser ablation mass analyzing apparatus according to claim 1, wherein the ion source includes a differential-pumping system, an ionization chamber, a repeller electrode, and an extraction electrode.

16. The laser ablation mass analyzing apparatus according to claim 1, wherein the analyzer includes a main vacuum pumping system, a mass separation region, and an ion detector.

17. The laser ablation mass analyzing apparatus according to claim 1, wherein a mass range of the mass separation region is in a range of 1-200 u and a mass resolution thereof is approximately 500.

18. The laser ablation mass analyzing apparatus according to claim 1, wherein the ion detector is a secondary electron multiplier.
